(19) United States
(12) Patent Application Publication
(10) Pub. No.: US 2010/0247848 A1
(43) Pub. Date: Sep. 30, 2010

(54) Sandwich element for sound-absorbing inner cladding of transport means, especially for sound-absorbing inner cladding of aircraft fuselage cells

(75) Inventors: Stephen Hötzeldt, Bremen (DE); Oliver Schindler, Bremen (DE); Steffen Erfurth, Bremen (DE); Bernd Ohlendorf, Bremen (DE); Malte Becker, Bremen (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 12/227,841

(22) PCT Filed: May 30, 2006
(86) PCT No.: PCT/EP2006/005161

§ 371 Date: Nov. 25, 2008

(51) Int. Cl. B64C 1/40; B32B 3/12

(52) U.S. Cl. 428/116

(57) ABSTRACT

A sandwich element for a sound-absorbing inner cladding of transport means, such as aircraft fuselage cells, comprising a honeycomb-shaped core structure and cover layers applied to both sides of the core structure. At least one cover layer is constructed as permeable to air at least in sections and a covering is disposed at least in sections on at least one cover layer, wherein a sound absorption layer is disposed at least in sections in the area of at least one cover layer.

A plurality of passages in the cover layers allow efficient transmission of the sound impinging on the sandwich element from outside as far as the sound absorption layer of the sandwich element.

### FIELD OF INVENTION

The invention relates to a sandwich element for a sound-absorbing inner cladding of transport means, especially for a sound-absorbing inner cladding of aircraft, comprising an especially honeycomb-shaped core structure and cover layers applied to both sides of the core structure.

### TECHNOLOGICAL BACKGROUND

Sandwich elements are widely used in aircraft construction. Of particular advantage here are the favourable mechanical properties which can be achieved with sandwich elements combined with a low weight. Known core structures in many cases have a honeycomb-shaped core structure with cover layers applied to both sides. The honeycomb-shaped core structure is characterised by repeated units which are closed in themselves, having a substantially hexagonal base surface. As a result of the cover layers being bonded to the honeycomb-shaped core structure, these repeated units form cells which are closed in themselves.

The increasingly higher requirements, for sound protection in modern aircraft construction make it necessary to use sandwich panels, especially when fitting aircraft with inner claddings, having good sound damping properties in addition to the advantageous mechanical properties.

Conventional sandwich panels which are constructed using honeycomb-shaped core structures, for example, generally do not have adequate sound absorption properties to satisfy current requirements for sound protection, especially when forming inner claddings of fuselage cells.

### SUMMARY OF INVENTION

An object of the invention is to provide a sandwich element, especially for forming sound-absorbing inner claddings for fuselage cells of aircraft which also has good sound absorption properties as a further development of the usual sandwich elements. In addition, the sandwich element should have a sufficient mechanical loading capacity and only a low weight at the same time. In addition, the sandwich element according to the invention should also have sufficient heat insulating properties.

The object is solved by a device having the features of claim 1.

Since at least one cover layer is constructed as permeable to air at least in sections and a covering is disposed at least in sections on at least one cover layer, wherein a sound absorption layer is disposed at least in sections in the area of at least one cover layer, the sandwich element according to the invention may have excellent sound absorption properties at the same time as a high mechanical loading capacity and a low weight. Sound impinging upon the sandwich element from outside may pass through the covering and at least one cover layer constructed as permeable to air, almost undamped through the core structure of the sandwich element and may then be largely absorbed in the sound absorption layer. The covering applied at least in sections to at least one cover layer may largely prevent any undesirable penetration of foreign bodies and/or liquids into the core structure. The sound absorption layer at the same time may bring about good heat insulation properties of the sandwich element.

According to a further exemplary embodiment, the cover comprises a plurality of openings, wherein the openings each have a cross-sectional area which largely prevents the penetration of foreign bodies and/or liquids and allows the transmission of sound.

The openings in the covering may ensure a largely unhindered transmission of sound incident on the sandwich element from outside.

According to a further exemplary embodiment, the cover layer or the cover layers have a plurality of passages wherein these passages have cross-sectional areas which allow the transmission of sound.

This embodiment initially may make it possible to apply the cover layers to the core structure largely in accordance with the known procedure for coating core structures because a sufficient number of webs may remain between the passages which in their entirety constitute an adequate area for bonding to the core structure located thereunder. In addition, the passages in the cover layers may allow almost undamped transmission of sound through the cover layers and the core structures as far as the sound absorption layer.

A further exemplary embodiment provides that the passages in the cover layer or in the cover layers preferably each have larger cross-sectional areas than the openings in the covering. This may ensure almost unhindered penetration of sound through the cover layers whereas the penetration of foreign bodies and/or liquids through the covering may be largely avoided.

Further exemplary embodiments of the arrangement are presented in the further claims.

### SHORT DESCRIPTION OF THE DRAWING

In the drawings:

FIG. 1 is an isometric view of a sandwich element according to an exemplary embodiment of the invention, and

FIG. 2 is an exploded isometric diagram of the sandwich element according to an exemplary embodiment of the invention.

### DETAILED DESCRIPTION OF AN EXEMPLARY EMBODIMENT

In the figures same or similar features are labelled with the same or similar reference signs.

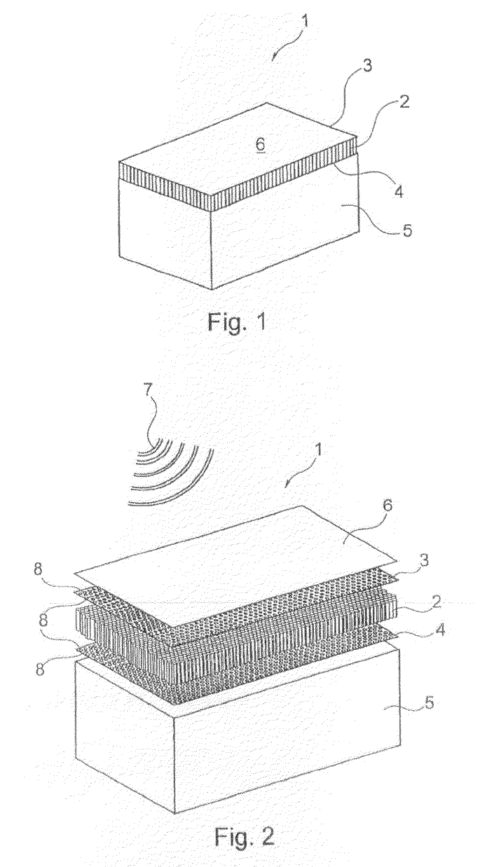

FIG. 1 shows an isometric view of the sandwich element according to an exemplary embodiment of the invention.

The sandwich element 1 comprises, among other things, a core structure 2 on which cover layers 3, 4 are applied to both sides. A sound absorption layer 5 is also disposed on the cover layer 4. A covering 6 is applied to the upper cover layer 3, preferably over the entire area, which covering allows the transmission of sound but largely prevents the penetration of foreign bodies and/or liquids into the core structure 2.

FIG. 2 shows an exploded isometric diagram of the sandwich element according to an exemplary embodiment of the invention.

The core structure 2 is formed in a known fashion by a plurality of adjoining honeycomb-shaped cells. After application of the cover layers 3, 4, the honeycomb-shaped cells each form small-volume repeating units which are closed in themselves. The sound absorption layer 5 for absorption of the incident sound is applied to the cover layer 4. As an auxiliary effect, the sound absorption layer 5 also improves the heat insulating properties of the sandwich element 1 according to the invention.

The covering 6 is preferably disposed over the entire area of the cover layer 3. The covering 6 reduces the penetration of foreign bodies and/or liquids into the core structure 2 and the sound absorption layer 5. The cover 6 comprises a plurality of openings which are not shown in detail in the drawing for the sake of better clarity. The openings preferably have such a small cross-sectional area that air and therefore also sound can pass through but liquids and/or foreign bodies are largely kept away from the inner area of the core structure 2. Sound waves 7 incident on the sandwich element 1 from outside thus pass largely undamped through the covering 6.

The cover layers 3, 4 also have a plurality of passages 8 of which only four, representative of the others, have been provided with a reference number for the sake of clarity of the drawing in the diagram in FIG. 2. The passages 8 are distributed substantially uniformly spaced apart from one another over the surfaces of the cover layers 3, 4, especially are arranged in matrix form. Compared with the openings in the covering 6, the passages 8 have considerably larger cross-sectional areas to allow the unhindered passage of sound waves 7 as far as possible. In addition, in contrast to the openings in the cover 6, the passages 8 does not need to prevent the undesired passage of foreign bodies and/or liquids into the core structure 2.

After crossing through the covering 6, the sound waves 7 impinge upon the cover layer 3, pass through the core structure 2, penetrate through the cover layer 4 and finally impinge almost undamped upon the sound absorption layer 5 in which the sound waves 7 are largely absorbed by conversion into heat. In the exemplary embodiment shown, the sound absorption layer 5 is applied over the entire area and directly to the cover layer 4. Alternatively, the sound absorption layer 5 can be arranged at a distance from the cover layer 4. In this case, an intermediate air space exists between the sound absorption layer 5 and the cover layer 4.

As a result of the largely loss-free transmission of sound through the covering 6, the cover layers 3, 4 and the core structure 1, in conjunction with the sound absorption layer 5, the sandwich element 1 according to the invention has a good sound damping effect. A further improvement in the sound damping effect can be achieved, for example, by the core structure 2 being additionally provided, at least in sections, with a sound-absorbing coating, for example, with a flocking of foamed plastics.

The sound absorption layer 5 can, for example, be formed using glass or mineral wool. Alternatively, the sound absorption layer 5 can also be formed using a spun yarn of fine metal fibres, carbon fibres, plastic fibres and also using open-pore foamed plastics. Alternatively the sound absorption layer 5 can also be formed using natural fibres.

The core structure 2 with the honeycomb-shaped cells can be formed using a fibre-reinforced plastic material, for example, using epoxy-resin-impregnated Nomex® paper or the like. Alternatively, the core structure 2 can also be formed using a metal material, for example, using aluminium, an aluminium alloy, steel or titanium.

In their end regions, that is in the respective region of bonding to one of the cover layers 3, 4, the honeycomb-shaped cells of the core structure 2 can each have one or more small slits having a relatively small cross-sectional area compared to the wall surface of the cell. Any condensate water which may be present in the honeycomb-shaped cells of the core structure 2 can flow off through these slits in a controlled manner. The slits are thus used in the broadest sense for drainage of the core structure 2. Moisture-induced damage to the core structure 2 by corrosion or rotting processes is hereby largely avoided. Alternatively, the cell walls of the honeycomb-shaped cells of the core structure 2 comprise openings, at least in sections, especially cylindrical passages arranged in the form of perforations.

The cover layers 3, 4 can, for example, be formed using a composite material made of a fibre-reinforced plastic material, for example, using carbon-fibre or glass-fibre-reinforced prepregs with epoxy resin or polyester resin. The passages 8 arranged in matrix form, for example, can then be incorporated in the prepregs to form the cover layers 3, 4 where, as a result of the plurality of passages 8 to be incorporated, a weakening of the entire fibre reinforcement of the cover layer 3,4 can occur, since the fibre reinforcement is usually separated in the area of the passages 8. In their entirety the passages 8 preferably form a surface-covering continuous perforation in the respective cover layer 3, 4.

The passages 8 can be incorporated, for example, by known mechanical drilling or stamping methods in the cover layers 3, 4. When the passages 8 are produced by drilling or stamping methods, the passages 8 preferably have a circular cross-sectional area. A cross-sectional geometry different from circular is also possible if corresponding tools are used.

In addition, the cover layers 3, 4 can also be formed using a surface knitted fabric or using a fabric-like resin-impregnated structure.

Strands can be used, for example, to form the surface knitted fabric. The strands are preferably spaced uniformly apart and arranged approximately parallel to one another to form a first layer. At least two layers arranged one above the other then form a surface knitted fabric which then has a coarse fabric-like structure. The layers are preferably arranged one above the other, twisted relative to one another at an angle greater than 0°. Furthermore, it is possible to interweave the strands alternately with one another at least in sections. The strands can be formed, for example, using glass, carbon, plastic or natural fibres which are impregnated with resin either before or after the formation of the layers to finally create the cover layers 3, 4.

Alternatively, it is also possible to use a surface knitted fabric having a net-like structure to form the cover layers 3, 4 where the strands are then knotted together or joined to one another in a different manner at the points of intersection of the network.

In principle, the cover layers 3, 4 formed by a surface knitted fabric have a coarse fabric-like or net-like structure. The meshes of the surface knitted fabric in this case each form the passages 8 of the cover layers 3, 4 where the meshes preferably each have a cross-sectional area smaller than the cross-sectional area of the respective cells of the honeycomb-shaped core structure 2 in order to achieve a sufficient mechanical bonding of the cover layers 3, 4 to the core structure 2. The cross-sectional geometries of the meshes depend on the structure of the surface knitted fabric used but generally differ from the circular shape.

The formation of the cover layers 3, 4 using a surface knitted fabric especially has the advantage that no mechanical processing of the starting material used to manufacture the cover layers 3, 4 is required to form the passages 8, for example, by drilling or stamping “prepregs”. This is because mechanical processing generally results in an undefined, at least local destruction of the fibre reinforcement in the area of the passages 8 and with this a deterioration in the mechanical properties of the sandwich element 1 formed therefrom. The same applies to non-mechanical processing of the starting material for the cover layers 3, 4, for example, for the incorporation of passages 8 in prepregs by laser processes, chemical processes or the like.

The cover layers 3, 4 can furthermore be formed using metal sheets, metal films or the like. In this case, in particular aluminium, an aluminium alloy, steel or titanium can be considered as metal material for the cover layers 3, 4. The advantage of using a metal material to form the cover layers 3, 4 is especially that the passages 8 can simply be formed by mechanical processing, for example, by stamping, drilling or the like, which do not result in any significant mechanical weakening of the material as is the case when drilling or stamping is incorporated in fibre-reinforced prepregs of composite material.

The cover layers 3, 4 can alternatively be formed using non-fibre-reinforced plastic materials, for example, using plastic films, plastic panels or foamed plastic panels.

In addition, both the cover layers 3,4 and also the core structure 2 can be formed using any combination of composite materials, fibre-reinforced plastic materials, foamed plastic materials, plastic materials and/or metal materials according to the type described previously.

The covering 6 can be formed using a surface structure or using a surface knitted fabric which on the one hand allows transmission of sound but on the other hand largely retains foreign bodies and/or liquids. Known semi-permeable membranes such as, for example GoreTex®, Sympatex®, or the like can be used to form the covering having a surface structure. Fabric or materials having the aforesaid properties can also be used as surface knitted fabric to form the covering 6.

The mechanical bonding of the cover layers 3, 4 to the core structure 2, the covering 6 and the sound absorption layer 5 is effected by known joining methods such as hot or cold adhesion methods or general welding methods, for example, depending on the type and condition of the materials to be joined. The joining can also take place by riveting, adhesive strips or the like.

For reasons of weight, the material thickness of the cover layers 3, 4 and the core structure 2 generally has relatively low values. The material thickness of the cover layers 3, 4 is usually less than 10 mm and the height of the core structure 2 is less than 50 mm. The sound absorption layer 5 preferably has a material thickness of less than 100 mm. The material thickness of the covering 6 is preferably less than 10 mm.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

### REFERENCE LIST

1 Sandwich element
2 Core structure
3 Cover layer
4 Cover layer
5 Sound absorption layer
6 Covering
7 Sound waves
8 Passage

1. A sandwich element for a sound-absorbing inner cladding of aircraft fuselage cells, the sandwich element comprising:
a honeycomb-shaped core structure and cover layers applied to both sides of the core structure,
wherein both cover layers each have a plurality of passages for sound transmission and wherein a covering formed using a semi-permeable membrane of a plastic material is disposed on the cover layer facing to the sound,
wherein the semi-permeable membrane made of the plastic material comprises a plurality of openings with a cross-sectional area such that the penetration of foreign bodies and/or liquids is largely prevented and sound transmission is allowed, and a sound absorption layer is formed on the cover layer facing away from the sound.

2. The sandwich element according to claim 1, wherein the openings and the passages are arranged so that they are distributed uniformly spaced apart from one another over the covering and the cover layers in a matrix form.

3. The sandwich element according to claim 1, wherein the core structure is formed using at least one of a resin-impregnated paper and a metal material comprising at least one of aluminium, an aluminium alloy, steel and titanium.

4. The sandwich element according to claim 1, wherein the cover layers are formed with at least one of a fiber-reinforced plastic material and a metal material comprising at least one of aluminium, an aluminium alloy, steel and titanium.
